(19) United States
(12) Patent Application Publication
(10) Pub. No.: US 2009/0245211 A1
(43) Pub. Date: Oct. 1, 2009

(54) Method and apparatus for providing system information in ofdma cellular system

(76) Inventors: Jae-Heung Kim, Daejon (KR); Byung-Han Ryu, Daejon (KR); Seung-Chan Bang, Daejon (KR)

Correspondence Address: STAAS & HALSEY LLP, SUITE 700, 1201 NEW YORK AVENUE, N.W., WASHINGTON, DC, 20005, US

(21) Appl. No.: 11/990,938

(22) PCT Filed: Aug. 24, 2006
(86) PCT No.: PCT/KR2006/003336

§ 371 Date: Feb. 25, 2008

(30) Foreign Application Priority Data
Aug. 26, 2005 (KR) 10-2005-0078986

(51) Int. Cl. H04W 72/04; H04J 3/00; H04W 40/00; H04W 88/02; H04B 7/208

(52) U.S. Cl. 370/336; 370/329; 370/344

(57) ABSTRACT

Provided is a method and apparatus for transmitting system information in an Orthogonal Frequency Division Multiple Access (OFDMA) cellular system. The system information transmitting method in a base station of a cellular system includes: generating a plurality of system information blocks that constitute the system information; generating a system information super frame including a main information block and the system information blocks; generating a system information broadcasting channel including the system information super frame; and allocating radio resources to the system information broadcasting channel in a Time Divisional Multiplexing (TDM) method.

### TECHNICAL FIELD

The present invention relates to a method and apparatus for transmitting system information in an Orthogonal Frequency Division Multiple Access (OFDMA) cellular system; and, more particularly, to a method for transmitting and receiving system information in an OFDMA cellular system, an OFDMA base station for transmitting the system information, and a terminal for receiving the system information.

### BACKGROUND ART

In a conventional Code Division Multiple Access (CDMA) cellular-type system suggested by the 3rd Generation Partnership Project (3GPP), system information is transmitted to terminals within the coverage of a base station through a broadcasting channel (BCH), which broadcasts data over the entire coverage of the base station.

In the 3GPP Wideband CDMA (WCDMA) system, system information including cell configuration information is composed of a main information block (MIB) and system information blocks (SIBs), and system information is transmitted in every frame.

System information transmitted through a broadcasting channel (BCH) is generally composed of 80 ms super frames, and each super frame is encoded on the basis of a 20 ms transmission time interval (TTI). System information includes system information blocks, a main information block and scheduling information.

The system information blocks include network information including a network identifier and information for controlling the mobility of a terminal, handover supporting information, common channel configuration information, network/base station access procedure information, information related to measurement and control of a network and a terminal, and timer and counter value information of a terminal.

As described above, system information including a plurality of system information blocks according to the content of the system information is repeatedly transmitted on the basis of a system information transmission cycle. A single SIB may be multiplexed and transmitted over a 20 ms-long TTI or a plurality of system information blocks may be multiplexed and transmitted over a 20 ms-long TTI. Each of the super frames, which constitute the entire system information, includes a main information block in the fore part, and the main information block includes configuration information of the system information blocks to thereby inform what system information blocks a broadcasting channel is composed of and inform positions of the system information blocks.

FIG. 1 shows a conventional system information transmission method in a wideband Code Division Multiple Access (WCDMA) cellular system.

Referring to FIG. 1, a user terminal 10 selects a base station A 21 having a strong signal to interference ratio (SIR) by using a common pilot signal transmitted from each base station 21, 22 or 23, receives a broadcasting channel 1 (BCH1) of a base station transmitted through a known modulation and coding methods, and checks out system information of the base station through demodulation and decoding. A terminal accesses to the base station by using the system information and exchanges data with a network.

FIG. 2 shows a system information super frame configuration and a radio frame mapping configuration in a conventional WCDMA cellular system.

Referring to FIG. 2, a base station forms a system information super frame 1 for transmitting system information and a transport block (TrBK) 2 for the transmission of system information. The transport block is formed through a layer 2 process in conformity to a system information transmission TTI, which is 20 ms, and a transport block has a total of 246 bits, 11 bits for system frame number (SFN) and 235 bits for system information.

Also, in a physical layer, i.e., layer 1, of the base station, a transport block 2 transmitted from an upper layer, which is a layer 2, is coded together with a 16-bit cyclic redundancy check (CRC) code in a convolutional coding at a coding rate of ½. Then, the coding result is mapped to two radio frames 3 having a cycle of 10 ms and transmitted. Terminals within a cell receive the system information of the cell to which they pertain through a broadcasting channel, access to the base station of the cell, and receive a needed service.

Therefore, not only terminals in the center of the cell where the radio channel environment of the broadcasting channel is fine but also terminals in the cell boundary where the radio channel environment is poor can accurately receive the system information.

At present, the 3GPP is working on standardization of a long term evolution (LTE) for high-speed transmission of packet data and adopts the Orthogonal Frequency Division Multiple Access (OFDMA) for multiple access.

Meanwhile, regardless of the multiple access method, a terminal needs system information to efficiently be connected to a network or receive mobile services in a cellular mobile communication system.

In conventional CDMA systems, codes are allocated to identify channels and users for data transmission. However, in the OFDMA cellular system, channels and users are identified by subcarrier index of a frequency axis and a symbol index of a time axis.

Also, differently from the CDMA method which is strong to interference between cells, which is referred to as an inter-cell interference, the OFDMA cellular system which is weak to the interference between cells requires a system information transmission method that can complement the weak point.

The intra-cell interference is negligible because subcarriers have secured orthogonality within a cell in the OFDMA system, but inter-cell interference is critical problem because they cannot have orthogonality secured in the cell boundary due to interference between cells. The interference between cells can be minimized by using an anti-collision method.

The inter-cell interference is one of the obstacles that blocks the application of the OFDMA method to the cellular mobile communication system, and researchers are studying to develop diverse cell interference alleviation methods. However, when the channel capacities of adjacent cells are fully loaded, it is difficult to avoid loss caused by the inter-cell interference.

Therefore, it is required to develop a new configuration of a broadcasting channel that can overcome the inter-cell interference and transmit system information, and a processing system for processing the system information.

### DISCLOSURE

### Technical Problem

It is, therefore, an object of the present invention to provide a system information transmission method that can prevent loss caused by inter-cell interference in an Orthogonal Frequency Division Multiple Access (OFDMA) cellular system, an OFDMA base station for providing system information, and a terminal therefor.

The other objects and advantages of the present invention can be understood by the following description and become apparent by the embodiment of the present invention. Also, it can be easily understood by those skilled in the art of the present invention that the objects and advantages of the present invention are defined by the means as claimed and combinations thereof.

### Technical Solution

In accordance with one aspect of the present invention, there is provided a method for transmitting system information in a base station of a cellular system, which includes the steps of: a) generating a plurality of system information blocks that constitute the system information; b) generating a system information super frame including a main information block and the system information blocks; c) generating a system information broadcasting channel including the system information super frame; and d) allocating radio resources to the system information broadcasting channel in a Time Divisional Multiplexing (TDM) and/or Frequency Divisional Multiplexing (FDM) method.

In accordance with another aspect of the present invention, there is provided a method for receiving system information in a terminal of a cellular system, which includes the steps of: a) receiving broadcasting channel radio signals including the system information; b) acquiring a super frame of the broadcasting channel by demodulating and decoding the received broadcasting channel radio signals; c) acquiring a main information block and system information blocks from the super frame; d) acquiring super frame transmission cycle information from the main information block; e) repeatedly receiving the broadcasting channel radio signals based on the super frame transmission cycle; and f) acquiring the system information by combining the system information blocks acquired from the repeatedly received broadcasting channel signals.

In accordance with another aspect of the present invention, there is provided a base station of a cellular system, which includes: a broadcasting channel generator for generating a system information broadcasting channel including a main information block and a plurality of system information blocks that constitute system information; and a transmitter for allocating radio resources to the system information broadcasting channel and repeatedly transmitting the system information broadcasting channel based on a predetermined system information broadcasting channel transmission cycle, wherein the main information block includes the system information broadcasting channel transmission cycle information.

In accordance with another aspect of the present invention, there is provided a terminal of a cellular system, which includes: a receiver for receiving broadcasting channel radio signals including system information, and acquiring a super frame of the broadcasting channel by demodulating and decoding the broadcasting channel radio signals; and a broadcasting channel processor for acquiring the system information by extracting a main information block and system information blocks form the super frame, extracting super frame transmission cycle information from the main information block, repeatedly receiving the broadcasting channel radio signals in the receiver based on the super frame transmission cycle, and combining the acquired system information blocks of the super frame.

### ADVANTAGEOUS EFFECTS

According to the present invention a broadcasting channel for transmitting system information is formed by allocating radio resources in a Time Divisional Multiplexing (TDM) or Frequency Divisional Multiplexing (FDM) in an Orthogonal Frequency Division Multiple Access (OFDMA) cellular system and transmitted. This way, a terminal at a cell boundary where a radio channel environment is poor can acquire the system information through repeated signal reception and symbol combination.

Also, the present invention can reduce power consumption of a terminal through a resource allocation at a base station based on subcarrier and symbol section designation for broadcasting channel and through a system information reception process holding.

### DESCRIPTION OF DRAWINGS

The above and other objects and features of the present invention will become apparent from the following description of the preferred embodiments given in conjunction with the accompanying drawings, in which:

FIG. 1 is a view describing a system information transmission method in a conventional Wideband Code Division Multiple Access (WCDMA) cellular system;

FIG. 2 is a view illustrating a configuration of a system information super frame and a radio frame mapping configuration in the conventional WCDMA cellular system;

FIG. 3 is a view showing a system information super frame in accordance with an embodiment of the present invention;

FIG. 4 is a view illustrating a transmission cycle of a system information super frame in accordance with an embodiment of the present invention;

FIG. 5 is a view showing a TDM allocation of a system information broadcasting channel (SBCH) in accordance with an embodiment of the present invention;

FIG. 6 is a block diagram showing an OFDMA base station in accordance with an embodiment of the present invention;

FIG. 7 is a block diagram showing an OFDMA terminal in accordance with an embodiment of the present invention;

FIG. 8 is a view showing an FDM allocation of an SBCH in accordance with an embodiment of the present invention;

FIG. 9 is a flowchart describing a system information transmission process in accordance with an embodiment of the present invention;

FIG. 10 is a flowchart describing a system information reception process in accordance with an embodiment of the present invention; and

FIG. 11 is a flowchart describing a system information transmission/reception process in accordance with an embodiment of the present invention.

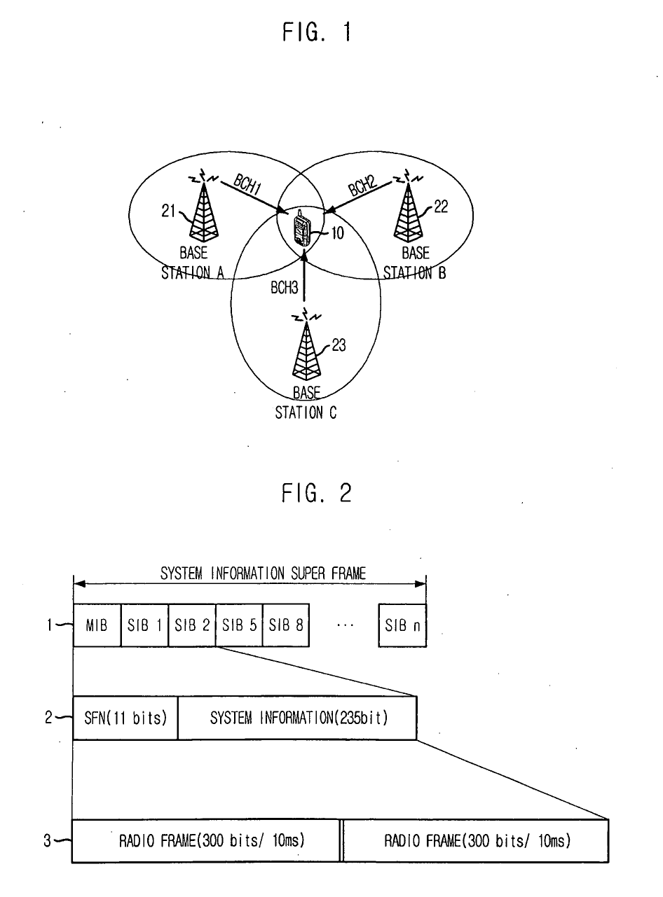

### BEST MODE FOR THE INVENTION

Following description exemplifies only the principles of the present invention. Even if they are not described or illustrated clearly in the present specification, one of ordinary skill in the art can embody the principles of the present invention and invent various apparatuses within the concept and scope of the present invention.

The use of the conditional terms and embodiments presented in the present specification are intended only to make the concept of the present invention understood, and they are not limited to the embodiments and conditions mentioned in the specification.

In addition, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flowcharts, state conversion diagrams, pseudo codes and the like can be expressed substantially in a computer-readable media, and whether or not a computer or a processor is described distinctively, they should be understood to express various processes operated by a computer or a processor.

Functions of various devices illustrated in the drawings including a functional block expressed as a processor or a similar concept can be provided not only by using hardware dedicated to the functions, but also by using hardware capable of running proper software for the functions. When a function is provided by a processor, the function may be provided by a single dedicated processor, single shared processor, or a plurality of individual processors, part of which can be shared.

The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

Other objects and aspects of the invention will become apparent from the following description of the embodiments with reference to the accompanying drawings, which is set forth hereinafter. Herein, the same reference number is given to the same constituent element although it appears in different drawings. Also, when it is considered that detailed description on a related art may obscure the points of the present invention, the description will not be provided herein.

Hereinafter, technological features of a general Orthogonal Frequency Division Multiple Access (OFDMA) cellular system, which is used in the present invention, will be described first, and then preferred embodiments of the present invention will be described with reference to the accompanying drawings.

Radio resources are allocated in a method of allocating subcarrier indexes in a frequency axis and symbol indexes in a time axis which indicate locations of the radio resources for data transmission in an OFDMA cellular system. System information broadcasting channel (SBCH) for transmission of system information also requires the two-dimensional allocation. The system information broadcasting channel which should be clearly distinguished from other channels may be allocated in a Time Divisional Multiplexing (TDM) method or a Frequency Divisional Multiplexing (FDM) method.

The TDM resource allocation is a method in which radio resources are allocated to some symbol sections in the time axis, and the FDM resource allocation is a method in which radio resources are allocated to some subcarrier bands in the frequency axis. The TDM resource allocation is favorable in the respect of low power consumption of the terminal when the radio resources are allocated for the transmission of system information. In the respect of avoiding inter-cell interference, the FDM resource allocation is favorable.

To minimize the interference power between cells in the OFDMA cellular system, when a frequency reuse factor is larger than 1, different frequencies are used for adjacent cells. When the same frequency is used in adjacent cells, partial subcarriers are used. When all cells use the same frequency with a frequency reuse efficiency of 1, a different subcarrier use pattern is used for each cell on a symbol basis to thereby alleviate interference between cells.

However, no matter what method is used, a terminal in the cell boundary requires a channel coding rate higher than that of the CDMA method even when the same modulation method is used to accurately receive system information of the cell and secure the radio channel quality. For example, in an OFDMA system of the IEEE 802.16c, which is a WiBro system in Korea, a coding rate of ⅙ is applied to terminals in the cell boundary to secure the radio channel quality and the system information is transmitted repeatedly. Thus, the coding rate reaches 1/12 substantially. In this system, terminals in the cell boundary can have a secured radio channel quality, but the applicability of radio resources, whose quantity is limited, is deteriorated.

The present invention forms a system information broadcasting channel suitably for an OFDMA system, transmits system information blocks repeatedly to a predetermined location in a TDM or FDM radio resource allocation at a predetermined cycle, and combines the system information blocks in a terminal to thereby overcome inter-cell interference with a relatively law coding rate.

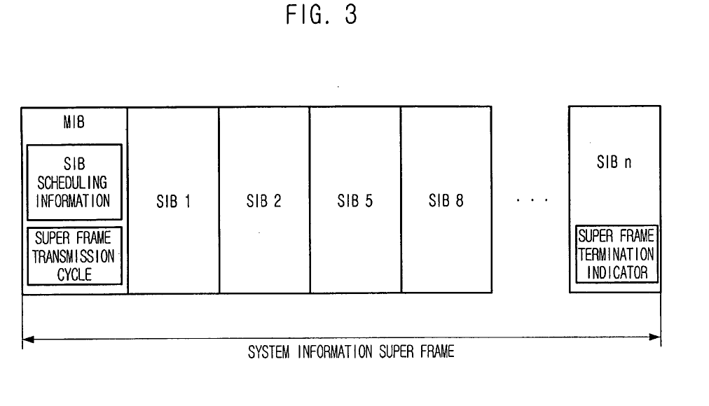

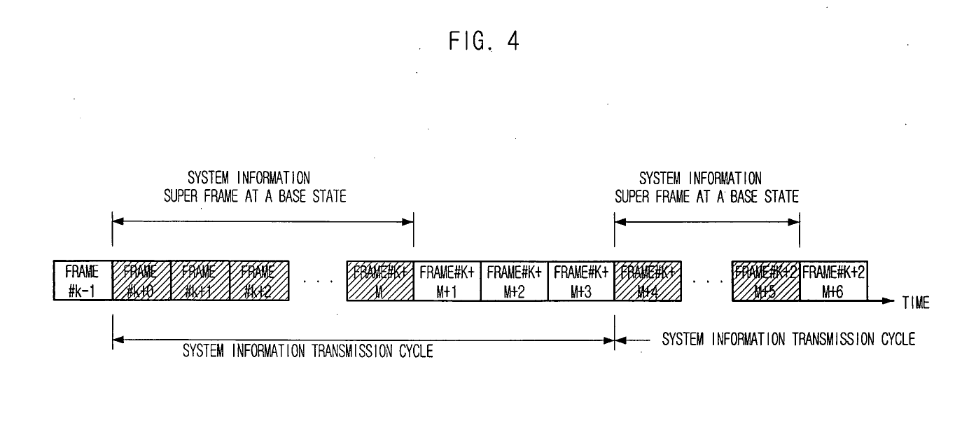

FIG. 3 shows a system information super frame in accordance with an embodiment of the present invention, and FIG. 4 illustrates a transmission cycle of a system information super frame.

Referring to FIG. 3, a system information super frame that constitutes a system information broadcasting channel is composed of a main information block (MIB) and a plurality of system information blocks (SIBs), and it is transmitted at a predetermined transmission cycle, which is shown in FIG. 4. Herein, the transmission cycle of a super frame is the same as the transmission cycle of system information broadcasting channel (SBCH).

The main information block includes configuration information of the system information blocks within a super frame, SIB scheduling information for indicating the appearance of an SIB, and a super frame transmission cycle information.

The system information blocks are composed of blocks needed by each cell among system information blocks defined for system information, and the last system information block of a system information super frame includes a super frame termination indicator.

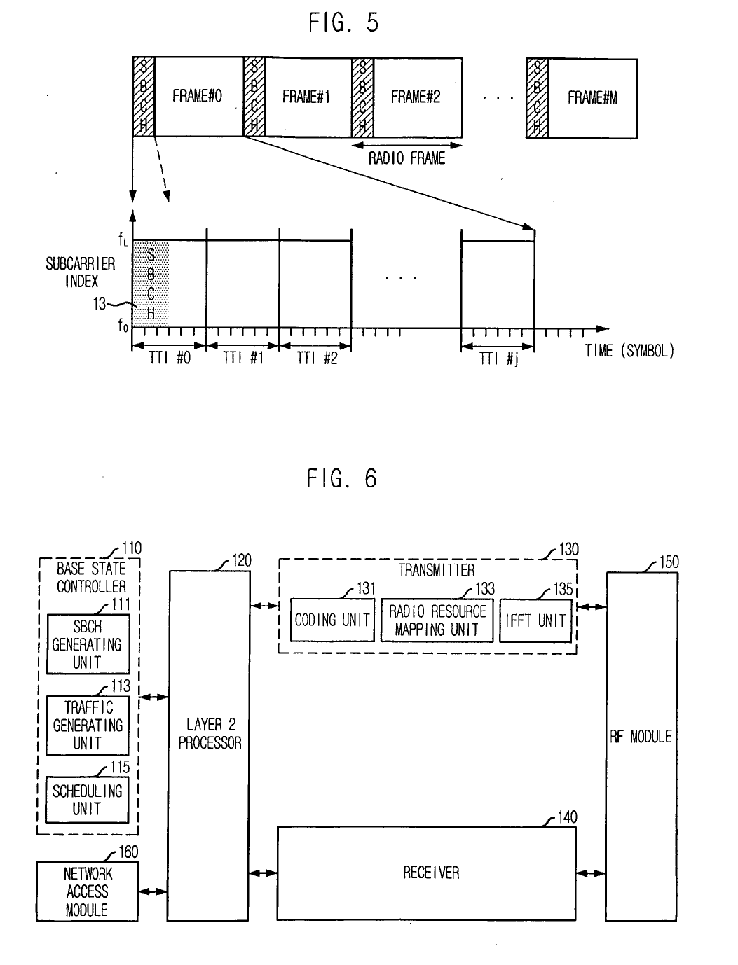

FIG. 5 is a view showing a TDM allocation of a system information broadcasting channel (SBCH) in accordance with an embodiment of the present invention.

Referring to FIG. 5, an arbitrary TTI is selected among transmission time intervals (TTIs) that form a radio frame, or slots, and system information broadcasting channel is transmitted to a predetermined symbol section on a time axis at the TTI by allocating radio resources in the TDM method in the present embodiment.

FIG. 6 is a block diagram showing an OFDMA base station in accordance with an embodiment of the present invention.

Referring to FIG. 6, an OFDMA base station includes a base station controller 110, a layer 2 processor 120, a transmitter 130, a receiver 140, and a radio frequency (RF) module 150.

The base station controller 110 generally manages control on the constituent elements of the base station.

Particularly, it generates super frames of a system information broadcasting channel and includes an SBCH generating unit 111, a traffic generating unit 113, and a scheduling unit 115.

The SBCH generating unit 111 generates a system information super frame based on network information transmitted from a network through a network access module 160 and cell information of each cell and transmits the system information super frame to the layer 2 processor 120.

The layer 2 processor 120 performs layer 2 process onto the inputted system information super frame, generates a transport block (TrBK) based on a predetermined TTI of a frame that should transmit system information, and outputs the transport block to the transmitter 130. Herein, the TTI may form a frame alone or together with the first TTI, or slot.

The transmitter 130 is in charge of digital processing of all transmission packet data including system information and data information to be transmitted from the base station to a terminal. The transmitter 130 includes a coding unit 131, a radio resource mapping unit 133, and an Inverse Fast Fourier Transform (IFFT) unit 135.

The coding unit 131 codes and outputs the transport block transmitted from the layer 2 processor 120.

The radio resource mapping unit 133 allocates radio resources to the coded information symbols such that the coded information symbols are transmitted through the radio resources indicated by a symbol section and a subcarrier designated for the transmission of the system information in the TTI. In the present invention, the radio resources are allocated in the TDM method according to the above-described embodiment with reference to FIG. 5.

The IFFT unit 135 performs IFFT onto the symbols mapped in the radio resource mapping unit 133 and outputs the result to the RF module 150.

The RF module 150 performs RF processing and transmits radio signals including a system information broadcasting channel to terminals.

Meanwhile, traffic data are transmitted through the network access module 160, just as the system information is. The traffic data are generated as a transport block in the layer 2 processor 120 under the control of the traffic generating unit 113 and the scheduling unit 115, and transmitted to the transmitter 130 at a TTI when the transport block should be transmitted.

The transmitter 130 codes the transmitted traffic transport block, modulates the traffic transport block in a modulation method through radio resource mapping, and transmits the modulated traffic transport block to the RF module 150 through the IFFT unit 135.

When the transmitter 130 receives the modulated traffic transport block and the system information transport block from the layer 2 processor 120 at the TTI of a frame at which a system information broadcasting channel is to be transmitted, both transport blocks are coded and the radio resource mapping unit 133 maps SBCH transport block to a symbol section allocated for the transmission of system information and radio resources indicated by a subcarrier, and maps traffic transport block to the other radio resources selected by the scheduling unit 115.

The transmitter 130 stores the coded SBCH system information and, if no control command that SBCH is updated is transmitted from the base station controller 110, the transmitter 130 repeatedly transmits the stored SBCH system information at a predetermined super frame transmission cycle, which is set as a multiple number of a frame or a TTI, to a predetermined location at the same adaptive modulation and channel coding (AMC) level.

The transmitter 130 codes the system information on the basis of an SBCH super frame, or a TTI, or a predetermined coding block unit for system information block. For this, the layer 2 processor 120 generates SBCH transport blocks based on the coding unit and outputs them to the transmitter 130.

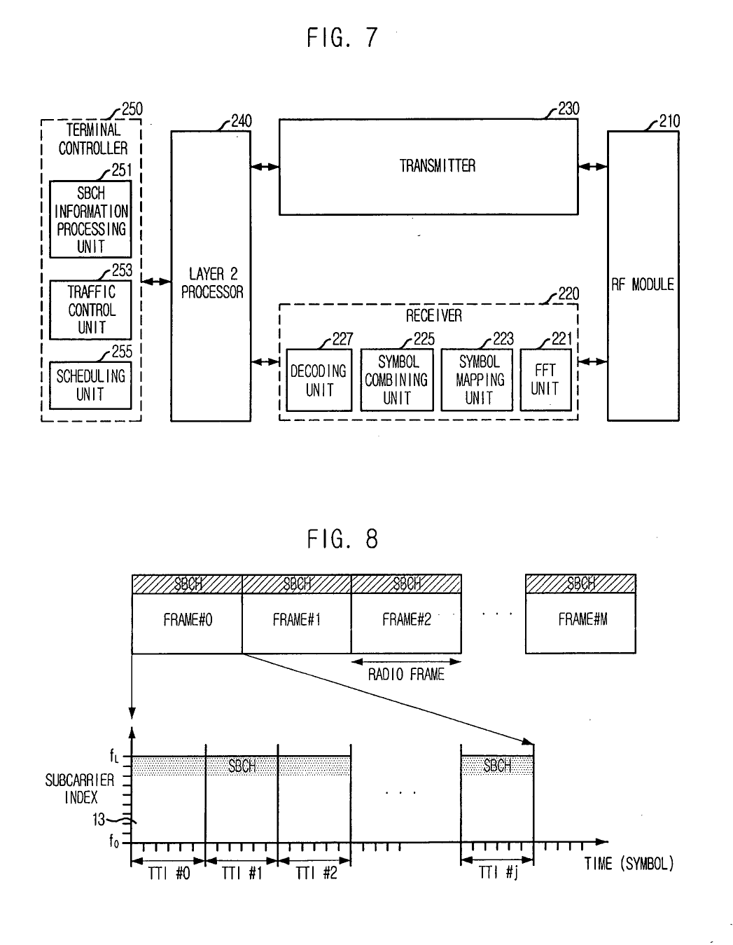

FIG. 7 is a block diagram showing an OFDMA terminal in accordance with an embodiment of the present invention.

Referring to FIG. 7, the OFDMA terminal includes an RF module 210, a receiver 220, a transmitter 230, a layer 2 processor 240, and a terminal controller 250.

Each terminal of a cell receives a system information broadcasting channel transmitted from a base station at its receiver 230 through the RF module 210.

The receiver 220 is in charge of processing digital signals to receive all packet data including system information and data which are transmitted from the base station to a terminal. The receiver 220 includes a Fast Fourier Transform (FFT) unit 221, a symbol mapping unit 223, a symbol combining unit 225, and a decoding unit 227.

The FFT unit 221 performs FFT onto signals of a used frequency bandwidth transmitted from the RF module 210, extracts reception signal symbol stream, and outputs the reception signal symbol stream to the symbol mapping unit 223.

The symbol mapping unit 223 modulates and codes the inputted reception signal symbol stream just as it does system information, or when a modulation and coding scheme (MCS) or an adaptive modulation and coding (AMC) level is predetermined, the symbol mapping unit 223 generates information bits and outputs the information bits to the decoding unit 227.

The decoding unit 227 decodes the received signal to thereby generate a system information broadcasting channel transport block (SBCH TrBK) and outputs it to the layer 2 processor 240.

With respect to channels operated variably without a predetermined modulation and coding levels, the decoding unit 227 checks the modulation and coding levels and performs demodulation and decoding based on the modulation and coding levels. Also, when traffic data are retransmitted based on a hybrid automatic repeat request (HARQ), when system information is repeatedly transmitted, or when system information or traffic data is transmitted from cells in the same e-Node B (eNB), the traffic data or the system information is soft-decided and stored in the symbol mapping unit 223 and combined with the same traffic data symbol or system information symbol soft-decided in the symbol combining unit 225 and outputted to the decoding unit 227 in order to acquire diversity gain.

The layer 2 processor 240 extracts a main information block and a system information block from the broadcasting channel transport block inputted from the decoding unit 227 by performing layer 2 process, acquires system information of a cell, and outputs the system information to the terminal controller 250.

The terminal controller 250 generally controls the constituent elements of the terminal, and it includes a broadcasting channel information (BCH) processing unit 251, a traffic control unit 253, and a scheduling unit 255 to process the received system information.

When the main information block and all the system information blocks are not extracted during a predetermined BCH super frame cycle, the BCH information processing unit 251 extracts the main information block and the system information blocks over a plurality of super frame cycles. Particularly, when the BCH system information is coded on a TTI basis, the BCH information processing unit 251 acquires the main information block and all system information blocks that form system information in an arbitrary super frame section, too.

When the system information blocks are all extracted in the arbitrary super frame section, the terminal controller 250 performs control to hold the process of SBCH system information in the receiver 220 until the next main information block appears.

FIG. 8 is a view showing an FDM allocation of an SBCH in accordance with an embodiment of the present invention. The present embodiment uses the FDM allocation method where a system information broadcasting channel is allocated to some designated subcarriers among the subcarriers available in a cell in all symbol sections of a frame or part of a TTI.

As shown in FIG. 8, arbitrary subcarriers are selected among the subcarriers of a radio frame and a system information broadcasting channel is transmitted in all symbol sections of an entire frame or part of a TTI on the time axis.

The configurations of a base station and a terminal when radio resources are allocated in the FDM method to transmit system information are almost the same as in the TDM method, which is described in the above with reference to FIGS. 5 and 6.

In the base station, when the layer 2 processor of the base station transmits a system information transport block and a traffic data transport block to the transmitter, the coding unit of the transmitter codes the system information transport block and the traffic data transport block, respectively, just as in the base station adopting the TDM method, and transmits the coded transport blocks by mapping radio resources thereto. The radio resource mapping unit receives SBCH symbols and data symbols simultaneously, maps the SBCH symbols to positions where subcarriers designated for system information appear at each symbol timing, maps the traffic data symbols to radio resources of the subcarrier selected by the scheduling unit, performs IFFT simultaneously, and transmits the result to the RF module.

The terminal receives data in the RF module, and transmits the received data to the FFT unit of the receiver according to the data reception time. The FFT unit performs FFT on a symbol basis, and it performs the FFT simultaneously on the system information symbols and traffic data symbols which exist at the same symbol timing in the TTI section where the system information exists and transmits the result to the symbol mapping unit. The subsequent operations after the symbol mapping are separated into operation for system information symbols and traffic data symbols and they are the same as in the terminal adopting the TDM method.

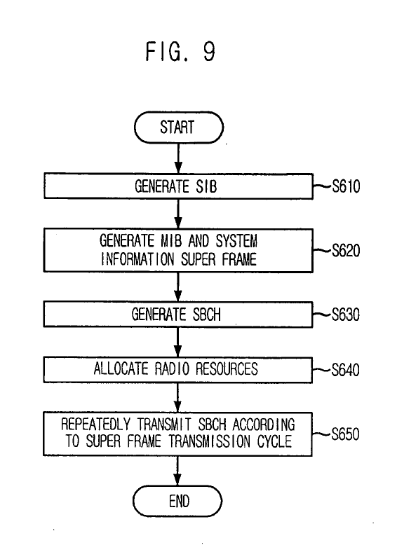

FIG. 9 is a flowchart describing a system information transmission process in accordance with an embodiment of the present invention.

In step S610, the SBCH generating unit 111 generates a plurality of system information blocks that constitute system information.

In step S620, the SBCH generating unit 111 generates a main information block and combines the system information blocks with the main information block to thereby generate a system information super frame. In step S630, it generates a system information broadcasting channel including the system information super frame. The system information broadcasting channel goes through layer 2 processing and then coded in the coding unit 141.

In step S640, the radio resource mapping unit 133 allocates radio resources to the system information broadcasting channel in the TDM method or the FDM method.

Subsequently, in step S650, the transmitter repeatedly transmits the system information broadcasting channel based on a predetermined super frame transmission cycle until the system information is updated.

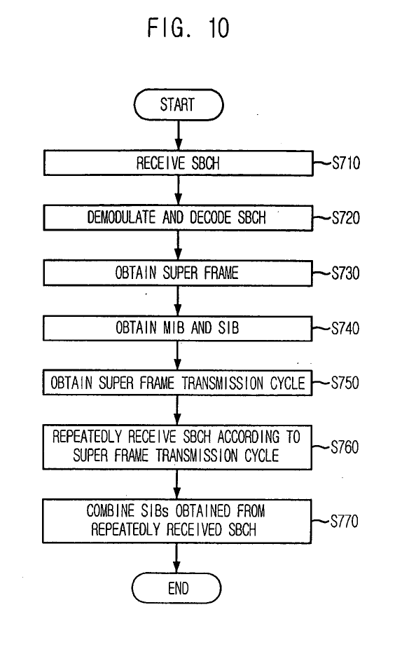

FIG. 10 is a flowchart describing a system information reception process in accordance with an embodiment of the present invention.

In step S710, the RF module 210 receives radio signals including the system information broadcasting channel.

In step S720, the receiver 220 demodulates and decodes the received radio signals including the system information broadcasting channel and, in step S730, the super frame of the system information broadcasting channel is acquired. In step S740, the main information block and the system information blocks are acquired from the super frame.

Subsequently, in step S750, the super frame transmission cycle is acquired from the main information block and, in step S760, radio signals including the system information broadcasting channel are repeatedly received based on the acquired super frame transmission cycle and the above process are repeated.

In step S770, the system information is acquired by combining the system information blocks acquired from the repeatedly received broadcasting channel signals.

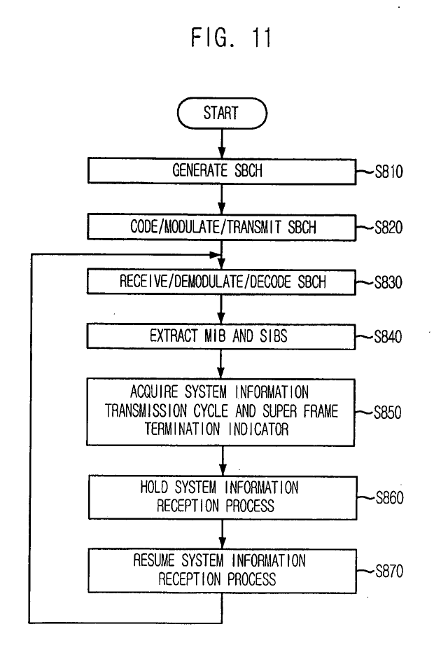

FIG. 11 is a flowchart describing a system information transmission/reception process in accordance with an embodiment of the present invention.

In step S810, the SBCH generating unit 111 of the base station controller 110 generates system information. In step S820, the layer 2 processor 120 performs layer 2 process onto the system information and the transmitter 130 codes the layer 2-processed system information, demodulates the coded system information, and transmits the demodulated system information.

Then, the receiver 220 of the terminal demodulates and decodes the received system information based on the FDM or TDM method during FFT and symbol mapping and transmits the decoded system information to the terminal controller 250 through the layer 2 processor 240.

In step S840, the SBCH information processing unit 251 of the terminal controller 250 extracts the main information block and the system information blocks from the received system information. In step S850, it acquires a super frame transmission cycle and a super frame termination indicator from the extracted main information block. Since the terminal acquires the super frame transmission cycle and the super frame termination indicator, which is included in the last system information block of a super frame, from the main information block, the terminal can save power consumption by holding the process for receiving the system information until the next super frame is transmitted. Also, when the main information block and all the system information blocks that constitute the system information are not extracted during an arbitrary SBCH super frame cycle, the main information block and the system information blocks can be extracted over a plurality of super frame cycles. Particularly, when the broadcasting channel system information is coded on a TTI basis, it is possible to acquire the main information block and all the system information blocks that constitute the system information in an arbitrary super frame section.

Subsequently, in step S860, when the terminal controller completes the extraction of the system information within an arbitrary super frame section, it sets up a system information reception process holding indicator to thereby the receiver holds the broadcasting channel system information reception process until the next main information block appears. Through the process, the terminal can reduce its power consumption. Also, when the system information broadcasting channel is mapped to all subcarriers available in a corresponding cell in multiple symbol sections in the fore part of a radio frame based on the TDM method, the terminal can hold the subsequent reception process after it determines that there is no data to be received. Thus, the terminal can reduce power consumption.

In step S870, the terminal which has held the system information reception process recognizes the symbol timing of a TTI at the system information broadcasting channel transmission cycle, resumes the reception process, and repeats the process from the step S830.

While the present invention has been described with respect to certain preferred embodiments, it will be apparent to those skilled in the art that various changes and modifications may be made without departing from the scope of the invention as defined in the following claims.

### INDUSTRIAL APPLICABILITY

The technology of the present invention can be applied to an OFDMA cellular system.

1. A method for transmitting system information in a base station of a cellular system, comprising:
generating a plurality of system information blocks that constitute the system information;
generating a system information super frame including a main information block and the system information blocks;
generating a system information broadcasting channel including the system information super frame; and
allocating radio resources to the system information broadcasting channel in a Time Divisional Multiplexing (TDM) method.

2. The method as recited in claim 1, wherein the main information block includes super frame transmission cycle information of the system information super frame.

3. The method as recited in claim 2, further comprising:
repeatedly transmitting the system information broadcasting channel based on the super frame transmission cycle.

4. The method as recited in claim 1, wherein a system information block at the end of the super frame includes a super frame termination indicator which indicates that the system information block is the last system information block of the super frame.

5. The method as recited in claim 2, wherein the main information block includes system information block scheduling information indicating that the super frame includes system information blocks.

6. A method for transmitting system information in a base station of a cellular system, comprising:
generating a plurality of system information blocks that constitute the system information;
generating a system information super frame including a main information block and the system information blocks;
generating a system information broadcasting channel including the system information super frame; and
allocating radio resources to the system information broadcasting channel in a Frequency Divisional Multiplexing (FDM) method.

7. The method as recited in claim 6, wherein the main information block includes super frame transmission cycle information of the system information super frame.

8. The method as recited in claim 7, further comprising:
repeatedly transmitting the system information broadcasting channel based on the super frame transmission cycle.

9. A method for receiving system information in a terminal of a cellular system, comprising:
receiving broadcasting channel radio signals including the system information;
acquiring a super frame of the broadcasting channel by demodulating and decoding the received broadcasting channel radio signals;
acquiring a main information block and system information blocks from the super frame;
acquiring super frame transmission cycle information from the main information block;
repeatedly receiving the broadcasting channel radio signals based on the super frame transmission cycle; and
acquiring the system information by combining the system information blocks acquired from the repeatedly received broadcasting channel signals.

10. The method as recited in claim 9, wherein radio resources are allocated to the broadcasting channel radio signals based on a TDM method.

11. The method as recited in claim 9, wherein radio resources are allocated to the broadcasting channel radio signals based on a TDM method.

12. A base station of a cellular system, comprising:
a broadcasting channel generator for generating a system information broadcasting channel including a main information block and a plurality of system information blocks that constitute system information; and
a transmitter for allocating radio resources to the system information broadcasting channel and repeatedly transmitting the system information broadcasting channel based on a predetermined system information broadcasting channel transmission cycle,
wherein the main information block includes the system information broadcasting channel transmission cycle information.

13. The base station as recited in claim 12, wherein the transmitter allocates radio resources to the system information broadcasting channel in a TDM method.

14. The base station as recited in claim 12, wherein the transmitter allocates radio resources to the system information broadcasting channel in a FDM method.

15. A terminal of a cellular system, comprising:
a receiver for receiving broadcasting channel radio signals including system information, and acquiring a super frame of the broadcasting channel by demodulating and decoding the broadcasting channel radio signals; and
a broadcasting channel processor for acquiring the system information by extracting a main information block and system information blocks form the super frame, extracting super frame transmission cycle information from the main information block, repeatedly receiving the broadcasting channel radio signals in the receiver based on the super frame transmission cycle, and combining the acquired system information blocks of the super frame.

16. The terminal as recited in claim 15, wherein radio resources are allocated to the system information broadcasting channel in a TDM method.

17. The terminal as recited in claim 15, wherein radio resources are allocated to the system information broadcasting channel in a FDM method.
